(19) United States
(12) Patent Application Publication
(10) Pub. No.: US 2021/0408614 A1
(43) Pub. Date: Dec. 30, 2021

(54) PORTABLE VEHICLE BATTERY PACK

(71) Applicant: K&N Engineering, Inc., Riverside, CA (US)

(72) Inventors: Wayne Jackson, Riverside, CA (US); Steve Williams, Cherry Valley, CA (US)

(73) Assignee: K&N Engineering, Inc., Riverside, CA (US)

(21) Appl. No.: 17/356,246

(22) Filed: Jun. 23, 2021

Related U.S. Application Data
(60) Provisional application No. 63/044,908, filed on Jun. 26, 2020.

(51) Int. Cl. H01M 10/46; H02J 7/00; H01M 10/0525; H01M 10/48; H01M 10/44; H01M 50/204; H01M 50/249; H01M 50/296; B60L 53/18; B60L 53/16

(52) U.S. Cl. CPC H01M 10/46; H02J 7/0047; H02J 7/0042; H01M 10/0525; H01M 10/482; H01M 10/488; H01M 2220/20; H01M 50/204; H01M 50/249; H01M 50/296; B60L 53/18; B60L 53/16; H01M 10/441

(57) ABSTRACT

An apparatus and methods are provided for a portable battery pack for recharging an onboard vehicle battery for extending driving range. The portable battery pack comprises a case that includes a base joined to a lid by way of hinges. A battery array is housed within the base, and electrical terminals are mounted onto the lid. A charging cable may be connected to the electrical terminals and plugged into a charge port of the vehicle. The battery array comprises a multiplicity of battery cells that may be coupled in parallel, in series, or a combination thereof. A battery management system is coupled with the battery array and configured to ensure that the battery array operates safely. The electrical terminals may be coupled with an external power inverter, or a power inverted may be housed within the case and incorporated into the power battery pack.

### PRIORITY

This application claims the benefit of and priority to U.S. Provisional Application, entitled “Portable Vehicle Battery Pack,” filed on Jun. 26, 2020 and having application Ser. No. 63/044,908, the entirety of said application being incorporated herein by reference.

### FIELD

Embodiments of the present disclosure generally relate to the field of electrically powered vehicles. More specifically, embodiments of the disclosure relate to a portable vehicle battery pack and methods for recharging onboard vehicle batteries for extending driving range.

### BACKGROUND

Electrically powered vehicles generally solve problems associated with the gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Unfortunately, electrically powered vehicles have certain drawbacks, including limited travel range between battery recharging and excessive time required for recharging the batteries. In generally, the average travel distance between battery recharging for currently available electrically powered vehicles is considerably less than the driving range of gasoline powered vehicles. Further, several hours may be required to recharge the batteries while the vehicle remains inoperative.

Increasing the driving range of electrically powered vehicles between battery recharging downtimes can significantly increase the desirability of operating electrically powered vehicles. One approach to increasing the driving range of an electrically powered vehicle is by charging the vehicle's battery by way of a portable battery pack that can be charged beforehand and stored onboard the vehicle. Although there have been many contributions to the art of electrically powered vehicles, significant improvements are needed to solve the short travel distance problems associated with such vehicles. There is a continuing interest, therefore, in developing battery recharging systems capable of extending the driving range of electrically powered vehicles during vehicle operation.

### SUMMARY

An apparatus and methods are provided for a portable battery pack for recharging an onboard vehicle battery for extending driving range. The portable battery pack comprises a case that includes a base joined to a lid by way of hinges. A battery array is housed within the base, and electrical terminals are mounted onto the lid. A charging cable may be connected to the electrical terminals and plugged into a charge port of the vehicle. The battery array comprises a multiplicity of battery cells that may be coupled in parallel, in series, or a combination thereof. A battery management system is coupled with the battery array and configured to ensure that the battery array operates safely. The electrical terminals may be coupled with an external power inverter, or a power inverted may be housed within the case and incorporated into the power battery pack.

In an exemplary embodiment, a portable battery pack comprises: a case including a base joined to a lid by way of hinges; a battery array housed within the base; and electrical terminals mounted onto the lid. In another exemplary embodiment, the portable battery pack further comprises a Hall Effect sensor configured for measuring at least the electric current passing into and out of the battery array. In another exemplary embodiment, the portable battery pack further comprises an LCD screen configured for displaying measured properties such as electric current and voltage during charging and discharging the battery array.

In another exemplary embodiment, the LCD screen is configured to facilitate controlling the electric current and/or voltage passing into and out of the battery array. In another exemplary embodiment, the portable battery pack is configured to recharge a battery onboard an electrically power vehicle. In another exemplary embodiment, the portable battery pack is configured to be charged by way of the electrical terminals. In another exemplary embodiment, the battery array comprises a multiplicity of battery cells that are coupled in parallel, in series, or a combination thereof. In another exemplary embodiment, the multiplicity of battery cells comprise lithium-ion battery cells having a size of 18650 and a capacity of at least 3,000 mAh.

In another exemplary embodiment, the battery array comprises more than 200 lithium-ion battery cells. In another exemplary embodiment, the battery array is coupled with a battery management system that is configured to ensure that the battery array operates within safe limits. In another exemplary embodiment, a switch and wires couple with the battery management system with the electrical terminals. In another exemplary embodiment, the switch is configured to turn on and off electric power to the electrical terminals.

In another exemplary embodiment, the electrical terminals comprise a positive terminal and a negative terminal. In another exemplary embodiment, the electrical terminals are configured to provide DC electricity from the battery array. In another exemplary embodiment, the electrical terminals are configured to be coupled with an external power inverter for recharging an onboard vehicle battery by way of the charging port of the vehicle. In another exemplary embodiment, a power inverted is housed within the case and integrated with the power battery pack. In another exemplary embodiment, the case includes a switch for selecting between DC and AC electric power being directed to the electrical terminals.

In an exemplary embodiment, a method for recharging an onboard vehicle battery comprises: coupling a charging cable with electrical terminals of a charged portable battery pack; plugging the charging cable into a charge port of a vehicle; using a switch to turn on the portable battery pack; selecting AC electric power to be directed the electrical terminals; monitoring measured properties by way of an LCD screen comprising the portable battery pack; and disconnecting the charging cable after charging the onboard vehicle battery. In another exemplary embodiment, selecting AC electric power includes utilizing a power inverted comprising the portable battery pack. In another exemplary embodiment, monitoring includes using the switch to turn off electric power to the electrical terminals once the onboard vehicle battery is desirable recharged.

These and other features of the concepts provided herein may be better understood with reference to the drawings, description, and appended claims.

### BRIEF DESCRIPTION OF THE DRAWINGS

The drawings refer to embodiments of the present disclosure in which:

FIG. 1 illustrates an exemplary embodiment of a portable vehicle battery pack that may be used to recharge a battery onboard an electrically power vehicle, in accordance with the present disclosure; and

FIG. 2 illustrates an exemplary embodiment of a battery array and battery management system that may be enclosed within a case comprising the portable vehicle battery pack of FIG. 1 according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first battery,” may be made. However, the specific numeric reference should not be interpreted as a literal sequential order but rather interpreted that the “first battery” is different than a “second battery.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

Electrically powered vehicles generally solve problems associated with the gasoline-powered vehicles, such as environmental pollution, noise and depletion of crude oil reserves due to the increasing use of gasoline-powered vehicles. As such, electrically powered vehicles are gaining in popularity and their use is becoming increasingly widespread. Drawbacks to electrically powered vehicles include limited travel range between battery recharging and excessive time required for recharging the batteries. Increasing the driving range of electrically powered vehicles between battery recharging downtimes can significantly increase the desirability of operating electrically powered vehicles. One approach to increasing the driving range of an electrically powered vehicle is by charging the vehicle's battery by way of a portable battery pack that can be charged beforehand and stored onboard the vehicle. Embodiments disclosed herein relate to a portable vehicle battery pack and methods for recharging onboard vehicle batteries for extending driving range.

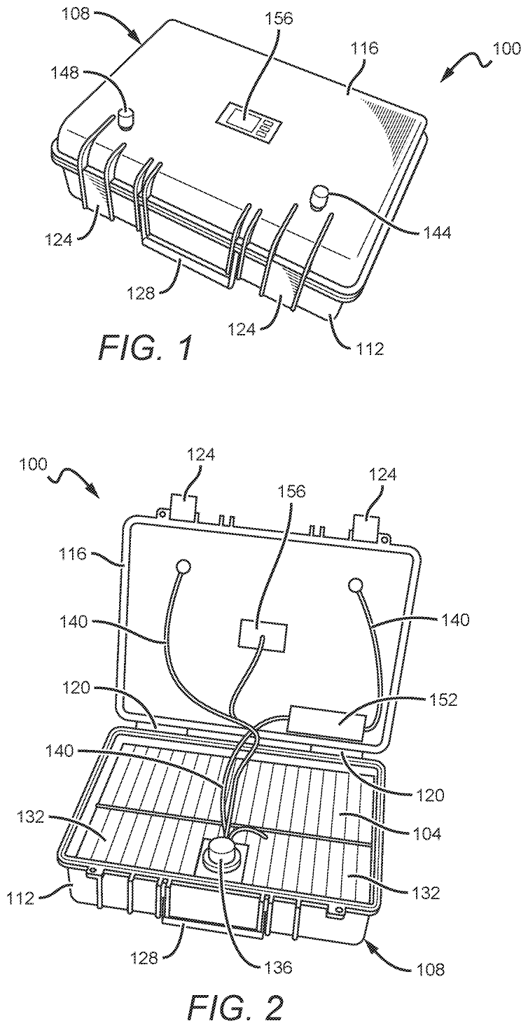

FIG. 1 illustrates an exemplary embodiment of a portable vehicle battery pack 100 that may be used to recharge a battery onboard an electrically power vehicle. The battery pack 100 includes a battery array 104 (see FIG. 2) housed within a protective case 108. The case 108 may be of a hard-plastic variety of case that includes a base 112 and a lid 116 that are joined by way of hinges 120. The plastic comprising the case 108 preferably is capable of withstanding the extreme temperature variations, such as high temperatures that generally are encountered in a locked vehicle during the summer months and freezing temperatures often encountered during the winter months. In some embodiments, the case 108 may be configured to provide a degree of insulation to the battery array 104 so as to protect the battery array 104 from extreme temperatures that may erode the performance of the battery pack 100.

The base 112 generally includes an interior volume suitable for storing the battery array 104 and accompanying circuitry. The lid 116 and hinges 120 facilitate opening the case 108 to access the battery array 104, as shown in FIG. 2. Clasps 124 are configured to enable retaining the case 108 in a closed configuration shown in FIG. 1. In some embodiments, the case 108 may be configured to be water resistant, and the clasps 124 may be configured to seal the case 108 to advantageously protect the battery array 104 from moisture, such as condensation arising within the vehicle during cold weather, as well as inclement weather that may be encountered during charging the vehicle. Further, the case 108 may include a handle 128 that enables a practitioner to easily transport the battery pack 100 by grasping the handle.

FIG. 2 illustrates an exemplary embodiment of a battery array 104 that may be enclosed within the interior of the case 108 as described herein. In general, the battery array 104 comprises a multiplicity of battery cells that may be coupled in parallel, in series, or a combination thereof, depending on the voltage and amperage that are intended to be received from the battery pack 100. For example, in one embodiment, the battery array 104 includes at least 200 lithium-ion battery cells having a size of 18650 and a capacity of at least 3,000 mAh, arranged to provide the battery pack 100 with an output of about 24 VDC and about 100 Amps. It should be understood, however, that the battery pack 100 is not limited to 18650-sized lithium-ion battery cells, but rather the battery pack 100 may include any of various types and sizes of battery cells, as well as any of various battery chemistries, as desired. Further, it is contemplated that the size and volume of the case 108 may be selected to accommodate any size and number of battery cells comprising the battery array 104, without limitation.

In the embodiment illustrated in FIGS. 1-2, the battery array 104 is coupled with a battery management system (BMS) 132. The BMS 132 generally is configured to ensure that the battery array 104 operates safely within acceptable limits. For example, in some embodiments, the BMS 132 may be configured to monitor any of total voltage, voltages of individual cells comprising the battery array 104, minimum and maximum cell voltages, voltage of periodic taps, average temperature, temperatures of individual cells, as well as current in and out of the battery array 104. In some embodiments, the BMS 132 may be configured to monitor a state of charge (SOC) or a depth of discharge (DOD) so as to indicate a charge level of the battery array 104. In some embodiments, the BMS 132 may be configured to monitor a remaining capacity of the battery array 104 calculated as percentage of the original capacity, often referred to as a state of health (SOH) of the battery array 104. Further, in some embodiments, the BMS 132 may be adapted to monitor an amount of power available from the battery array 104 for a defined time interval, given at least a current power usage and temperature of the battery array 104.

As further shown in FIG. 2, the battery pack 100 may include a switch 136 and wires 140 that couple the BMS 132 with a positive terminal 144 and a negative terminal 148 that are mounted onto the lid 116, as shown in FIG. 1. The positive and negative terminals 144, 148 are configured to enable the practitioner to withdraw direct current (DC) electricity from the battery pack 100. The switch 136 generally is configured to enable the practitioner to turn on and off electric power to the terminals 144, 148. As such, the practitioner may couple a suitable charging cable with the terminals 144, 148, plug the cable into a charge port of a vehicle to be charged, and then use the switch 136 to be begin recharging an onboard battery of the vehicle by way of the battery pack 100. Once the onboard vehicle battery has been desirably recharged, the switch 136 may be used to turn off electric power to the terminals 144, 148 before the charging cable is removed from the charge port of the vehicle and the terminals of the battery pack 100.

It is contemplated that the battery pack 100 may be charged by way of the positive and negative terminals 144, 148. In some embodiments, a charging cable may be coupled with the terminals 144, 148 and plugged into a suitable charging station. Upon the switch 136 being turned on, the battery pack 100 may be charged similarly to charging an onboard vehicle battery. Further, in some embodiments, the terminals 144, 148 may be coupled with an onboard charging cable such that the battery pack 100 is recharged by way of the onboard vehicle battery when the vehicle is plugged into a charging station. It is contemplated that in such embodiments, the onboard charging cable includes battery monitoring circuitry capable of ensuring safe charging of the battery pack 100.

In some embodiments, such as the embodiment shown in FIG. 2, a Hall Effect sensor 152 may be joined with the wires 140 and coupled with an LCD screen 156 mounted onto the lid 116, as shown in FIG. 1. The Hall Effect sensor 152 may be configured to measure at least the electric current passing into battery pack 100 during recharging, as well as measuring the electric current passing out of the battery pack 100 during charging the onboard vehicle battery. As will be appreciated, the LCD screen 156 may be configured to display measured properties, such as electric current and voltage, to the practitioner using the battery pack 100. In some embodiments, the LCD screen 156 may be configured with circuitry and switches that enable the practitioner to control the electric current and/or voltage passing into or out of the battery pack 100, as desired.

In some embodiments, the positive and negative terminals 144, 148 may be coupled with an external power inverter configured to convert the DC output of the battery pack 100 to an alternating current (AC) suitable for recharging the onboard vehicle battery by way of the charge port of the vehicle. In some embodiments, the power inverter may be integrated with the power pack 100 and thus housed within the case 108. In such embodiments, a switch may be incorporated into the battery pack 100 that enables the practitioner to select between DC and AC electric power being directed to the positive and negative terminals 144, 148. It should be borne in mind, therefore, that the battery pack 100 of the present disclosure is not limited to recharging electric vehicle batteries, but rather the battery pack 100 may be used to supply AC and DC electricity to a wide variety of electric devices in addition to electric vehicle batteries, without limitation, and without deviating beyond the spirit and scope of the present disclosure.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A portable battery pack, comprising:
a case including a base joined to a lid by way of hinges;
a battery array housed within the base; and
electrical terminals mounted onto the lid.

2. The portable battery pack of claim 1, further comprising a Hall Effect sensor configured for measuring at least the electric current passing into and out of the battery array.

3. The portable battery pack of claim 1, further comprising an LCD screen configured for displaying measured properties such as electric current and voltage during charging and discharging the battery array.

4. The portable battery pack of claim 3, wherein the LCD screen is configured to facilitate controlling the electric current and/or voltage passing into and out of the battery array.

5. The portable battery pack of claim 1, wherein the portable battery pack is configured to recharge a battery onboard an electrically power vehicle.

6. The portable battery pack of claim 1, wherein the portable battery pack is configured to be charged by way of the electrical terminals.

7. The portable battery pack of claim 1, wherein the battery array comprises a multiplicity of battery cells that are coupled in parallel, in series, or a combination thereof.

8. The portable battery pack of claim 7, wherein the multiplicity of battery cells comprise lithium-ion battery cells having a size of 18650 and a capacity of at least 3,000 mAh.

9. The portable battery pack of claim 1, wherein the battery array comprises more than 200 lithium-ion battery cells.

10. The portable battery pack of claim 1, wherein the battery array is coupled with a battery management system that is configured to ensure that the battery array operates within safe limits.

11. The portable battery pack of claim 1, wherein a switch and wires couple with the battery management system with the electrical terminals.

12. The portable battery pack of claim 11, wherein the switch is configured to turn on and off electric power to the electrical terminals.

13. The portable battery pack of claim 1, wherein the electrical terminals comprise a positive terminal and a negative terminal.

14. The portable battery pack of claim 1, wherein the electrical terminals are configured to provide DC electricity from the battery array.

15. The portable battery pack of claim 1, wherein the electrical terminals are configured to be coupled with an external power inverter for recharging an onboard vehicle battery by way of the charging port of the vehicle.

16. The portable battery pack of claim 1, wherein a power inverted is housed within the case and integrated with the power battery pack.

17. The portable battery pack of claim 16, wherein the case includes a switch for selecting between DC and AC electric power being directed to the electrical terminals.

18. A method for recharging an onboard vehicle battery, comprising:
coupling a charging cable with electrical terminals of a charged portable battery pack;
plugging the charging cable into a charge port of a vehicle;
using a switch to turn on the portable battery pack;
selecting AC electric power to be directed the electrical terminals;
monitoring measured properties by way of an LCD screen comprising the portable battery pack; and
disconnecting the charging cable after charging the onboard vehicle battery.

19. The method of claim 18, wherein selecting AC electric power includes utilizing a power inverted comprising the portable battery pack.

20. The method of claim 18, wherein monitoring includes using the switch to turn off electric power to the electrical terminals once the onboard vehicle battery is desirable recharged.
